(19) United States
(12) Patent Application Publication
(10) Pub. No.: US 2024/0388983 A1
(43) Pub. Date: Nov. 21, 2024

(54) PREDICTION OF A TIME DELAY FOR TRIGGERING A HANDOVER

(71) Applicant: Nokia Technologies Oy, Espoo (FI)

(72) Inventors: Ayaz AHMED, Bangalore (IN); Mads LAURIDSEN, Aalborg (DK); István Zsolt KOVÁCS, Aalborg (DK); Jedrzej STANCZAK, Wroclaw (PL)

(21) Appl. No.: 18/578,624

(22) PCT Filed: Jul. 8, 2022
(86) PCT No.: PCT/EP2022/069090

§ 371 Date: Jan. 11, 2024

(30) Foreign Application Priority Data
Aug. 2, 2021 (IN) 202141034666

(51) Int. Cl. H04W 36/00; H04W 36/30

(52) U.S. Cl. CPC H04W 36/00837; H04W 36/302

(57) ABSTRACT

An apparatus, method and computer program is described comprising: determining, at a user device of a mobile communication system, one or more parameters of a serving cell and one or more target cells at a first time instance; and estimating one or more time delay metrics for each of the one or more target cells based on said parameters, such that an optimal time point for performing a handover can be determined. The time delay metrics comprise one or more of: a first time delay corresponding to a time period between the first time instance and a time instance at which a signal strength of the serving cell is predicted to match a signal strength of the respective target cell; and a second time delay corresponding to a time period between the first time instance and a time instance at which the signal strength of the respective target cell is predicted to be higher than the signal strength of the serving cell by an offset value.

### FIELD

The present specification relates to handovers, such as handovers in mobile communication systems.

### BACKGROUND

Changing signals strengths as experienced at a user device of a mobile communication systems can lead to the need for a handover from a current serving cell to another (target) target cell of the mobile communication system. Handover can be challenging, for example, in mobile communication systems that experience significant signal propagation delays. There remains a need for further improvements in this field.

### SUMMARY

In a first aspect, this specification describes an apparatus (e.g. a user device or user equipment) comprising means for performing: determining, at a user device of a mobile communication system, one or more parameters of a serving cell and one or more target cells at a first time instance; and estimating one or more time delay metrics for each of the one or more target cells based on said parameters, such that an optimal time point for performing a handover can be determined, wherein the time delay metrics comprise one or more of: a first time delay corresponding to a time period between the first time instance and a time instance at which a signal parameter (e.g. signal strength and/or signal quality) of the serving cell is predicted to match a signal parameter of the respective target cell; and a second time delay corresponding to a time period between the first time instance and a time instance at which the signal parameter of the respective target cell is predicted to be higher than the signal parameter of the serving cell by an offset value (such as a cell individual offset). The mobile communication system may be a non-terrestrial network.

Some embodiments further comprise means for performing: sending some or all of said time delay metrics to a network node of the mobile communication system for use in determining the optimal time point for performing said handover.

Some embodiments further comprise means for performing: receiving configuration information from a/the network node of the mobile communication system for configuring the user device to estimate said time delay metrics. The configuration information may be comprised in a radio resource control message. The configuration information may identify the first time instance or provide a trigger condition for identifying said first time instance.

The parameters may comprise signal parameter rates of change of the serving cell and the one or more target cells. The signal cell rates of change may be based on two or more RSRP or similar measurement samples (which may be filtered) that are separated in time. The signal parameter rates of change may relate to a rate of change of radio signal received power and/or radio signal received quality measurements measured by the user device.

The means may comprise: at least one processor; and at least one memory including computer program code, the at least one memory and the computer program code configured, with the at least one processor, to cause the performance of the apparatus.

In a second aspect, this specification describes an apparatus (e.g. a network node of a mobile communication system) comprising means for performing: sending configuration information to a user device of a mobile communication system, such that the user device is caused to: determine one or more parameters of a serving cell and one or more target cells at a first time instance; and estimate one or more time delay metrics for each target cell based on said parameters, wherein the time delay metrics comprise one or more of: a first time delay corresponding to a time period between the first time instance and a time instance at which the signal parameter of the serving cell is predicted to match the signal parameter of the respective target cell; and a second time delay corresponding to a time period between the first time instance and a time instance at which the signal parameter of the respective target cell is predicted to be higher than the signal parameter of the source cells by an offset value (such as cell individual offset); receiving some or all of said time delay metrics from the user device; and determining an optimal time point for performing a handover based on the one or more time delay metrics received from the user device. The mobile communication system may be a non-terrestrial network.

Some embodiments further comprise means for performing: initiating a handover command based on the determined optimal time point.

Some embodiments further comprise means for performing: receiving the first time instance and/or some or all of said parameters from said user device. Some embodiments further comprise means for performing: estimating, based at least in part on said parameters, a time instance at which signal parameter of the serving cell will fall below a threshold (e.g. where a serving cell becomes too weak).

Some embodiments further comprise means for performing: identifying and preparing suitable target cell and/or updating an existing list of target cells. In some examples, the example embodiments may be implemented in a conditional handover (CHO).

The configuration information may be comprised in a radio resource control message. Further, the configuration information may identify said first time instance or provide a trigger condition for identifying said first time instance.

The parameters may comprise signal parameter rates of change of the serving cell and the one or more target cells. The signal cell rates of change may be based on two or more RSRP or similar measurement samples (which may be filtered) that are separated in time. The signal parameter rates of change may relate to a rate of change of radio signal received power and/or radio signal received quality measurements measured by the user device.

The means may comprise: at least one processor; and at least one memory including computer program code, the at least one memory and the computer program code configured, with the at least one processor, to cause the performance of the apparatus.

In a third aspect, this specification describes a system comprising: a network node and a user device of a mobile communication system (such as a non-terrestrial network). In the third aspect, the user device is configured to perform: determining one or more parameters of a serving cell and one or more target cells at a first time instance; and estimating one or more time delay metrics for each of the one or more target cells based on said parameters, wherein the time delay metrics comprise one or more of: a first time delay corresponding to a time period between the first time instance and a time instance at which a signal parameter of the serving cell is predicted to match a signal parameter of one of the target cells; and a second time delay corresponding to a time period between the first time instance and a time instance at which the signal parameter of the respective target cell is predicted to be higher than the signal parameter of the serving cell by an predefined offset value. Further, the network node is configured to perform: sending configuration information to the user device of the mobile communication system, such that the user device is caused to: determine said parameters of said serving cell and one or more target cells at said first time instance; and estimate said one or more time delay metrics based on the signal parameter rates of change; receiving some or all of said time delay metrics from the user device; and determining an optimal time point for performing a handover based on the one or more time delay metrics received from the user device.

The user device of the third aspect may comprise one or more features of the first aspect described above. Similarly, the network node of the third aspect many comprise one or more features of the second aspect described above.

In a fourth aspect, this specification describes a method comprising: determining, at a user device of a mobile communication system, one or more parameters of a serving cell and one or more target cells at a first time instance; and estimating one or more time delay metrics for each of the one or more target cells based on said parameters, such that an optimal time point for performing a handover can be determined, wherein the time delay metrics comprise one or more of: a first time delay corresponding to a time period between the first time instance and a time instance at which a signal parameter of the serving cell is predicted to match a signal parameter of the respective target cell; and a second time delay corresponding to a time period between the first time instance and a time instance at which the signal parameter of the respective target cell is predicted to be higher than the signal parameter of the serving cell by an offset value. The mobile communication system may be a non-terrestrial network.

The method may comprise sending some or all of said time delay metrics to a network node of the mobile communication system for use in determining the optimal time point for performing said handover.

The method may comprise receiving configuration information from a/the network node of the mobile communication system for configuring the user device to estimate said time delay metrics.

The parameters may comprise signal parameter rates of change of the serving cell and the one or more target cells.

In a fifth aspect, this specification describes a method comprising: sending configuration information to a user device of a mobile communication system, such that the user device is caused to: determine one or more parameters of a serving cell and one or more target cells at a first time instance; and estimate one or more time delay metrics for each target cell based on said parameters, wherein the time delay metrics comprise one or more of: a first time delay corresponding to a time period between the first time instance and a time instance at which a signal parameter of the serving cell is predicted to match a signal parameter of the respective target cell; and a second time delay corresponding to a time period between the first time instance and a time instance at which the signal parameter of the respective target cell is predicted to be higher than the signal parameter of the source cells by an offset value; receiving some or all of said time delay metrics from the user device; and determining an optimal time point for performing a handover based on the one or more time delay metrics received from the user device. The mobile communication system may be a non-terrestrial network.

The method may comprise initiating a handover command based on the determined optimal time point.

The method may comprise: receiving the first time instance and/or some or all of said parameters from said user device. The method may comprise estimating, based at least in part on said parameters, a time instance at which signal parameter of the serving cell will fall below a threshold (e.g. where a serving cell becomes too weak).

The method may comprise identifying and preparing suitable target cell and/or updating an existing list of target cells.

The parameters may comprise signal parameter rates of change of the serving cell and the one or more target cells.

In a sixth aspect, this specification describes a method implemented by a system comprising a network node and a user device of a mobile communication system. In the sixth aspect, the system may implement any method as described with reference to the fourth aspect and any method as described with reference to the fifth aspect.

In a seventh aspect, this specification describes an apparatus configured to perform (at least) any method as described with reference to the fourth to sixth aspects.

In an eighth aspect, this specification describes computer-readable instructions which, when executed by a computing apparatus, cause the computing apparatus to perform (at least) any method as described with reference to the fourth to sixth aspects.

In a ninth aspect, this specification describes a computer-readable medium (such as a non-transitory computer-readable medium) comprising program instructions stored thereon for performing (at least) any method as described with reference to the fourth to sixth aspects.

In a tenth aspect, this specification describes an apparatus comprising: at least one processor; and at least one memory including computer program code which, when executed by the at least one processor, causes the apparatus to perform (at least) any method as described with reference to the fourth to sixth aspects.

In an eleventh aspect, this specification describes a computer program comprising instructions for causing an apparatus to perform at least the following: determining, at a user device of a mobile communication system, one or more parameters of a serving cell and one or more target cells at a first time instance; and estimating one or more time delay metrics for each of the one or more target cells based on said parameters, such that an optimal time point for performing a handover can be determined, wherein the time delay metrics comprise one or more of: a first time delay corresponding to a time period between the first time instance and a time instance at which a signal parameter of the serving cell is predicted to match a signal parameter of the respective target cell; and a second time delay corresponding to a time period between the first time instance and a time instance at which the signal parameter of the respective target cell is predicted to be higher than the signal parameter of the serving cell by an offset value.

In a twelfth aspect, this specification describes a computer program comprising instructions for causing an apparatus to perform at least the following: sending configuration information to a user device of a mobile communication system, such that the user device is caused to: determine one or more parameters of a serving cell and one or more target cells at a first time instance; and estimate one or more time delay metrics for each target cell based on said parameters, wherein the time delay metrics comprise one or more of: a first time delay corresponding to a time period between the first time instance and a time instance at which the signal parameter of the serving cell is predicted to match the signal parameter of the respective target cell; and a second time delay corresponding to a time period between the first time instance and a time instance at which the signal parameter of the respective target cell is predicted to be higher than the signal parameter of the source cells by an offset value; receiving some or all of said time delay metrics from the user device; and determining an optimal time point for performing a handover based on the one or more time delay metrics received from the user device.

In a thirteenth aspect, this specification describes an apparatus, such as a user device, comprising a control module (or some other means) for: determining one or more parameters of a serving cell and one or more target cells at a first time instance; and estimating one or more time delay metrics for each of the one or more target cells based on said parameters, such that an optimal time point for performing a handover can be determined. The time delay metrics comprise one or more of: a first time delay corresponding to a time period between the first time instance and a time instance at which a signal parameter of the serving cell is predicted to match a signal parameter of the respective target cell; and a second time delay corresponding to a time period between the first time instance and a time instance at which the signal parameter of the respective target cell is predicted to be higher than the signal parameter of the serving cell by an offset value.

In a fourteenth aspect, this specification describes an apparatus comprising an output (or some other means) for sending configuration information to a user device of a mobile communication system, such that the user device is caused to: determine one or more parameters of a serving cell and one or more target cells at a first time instance; and estimate one or more time delay metrics for each target cell based on said parameters, wherein the time delay metrics comprise one or more of: a first time delay corresponding to a time period between the first time instance and a time instance at which the signal parameter of the serving cell is predicted to match the signal parameter of the respective target cell; and a second time delay corresponding to a time period between the first time instance and a time instance at which the signal parameter of the respective target cell is predicted to be higher than the signal parameter of the source cells by an offset value. The apparatus further comprises a receiver or input (or some other means) for receiving some or all of said time delay metrics from the user device and a control module (or some other means) for determining an optimal time point for performing a handover based on the one or more time delay metrics received from the user device.

### BRIEF DESCRIPTION OF DRAWINGS

Example embodiments will now be described, by way of non-limiting examples, with reference to the following schematic drawings, in which:

FIG. 1 is a block diagram of a mobile communication system in accordance with an example embodiment;

FIG. 2 is a plot showing signal strength data in accordance with an example embodiment;

FIG. 3 is a flow chart showing an algorithm in accordance with an example embodiment;

FIG. 4 is a plot showing signal strength data in accordance with an example embodiment;

FIGS. 5 to 7 are flow charts showing algorithms in accordance with example embodiments;

FIG. 8 is a message sequence in accordance with an example embodiment;

FIG. 9 is a block diagram of components of a system in accordance with an example embodiment; and

FIG. 10 shows tangible media storing computer-readable code which when run by a computer may perform methods according to example embodiments described above.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

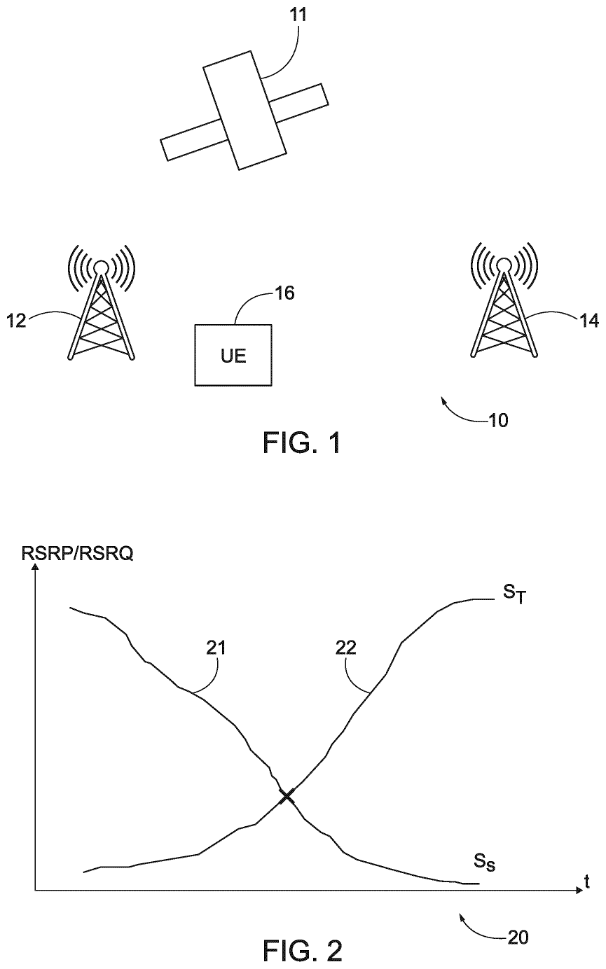

FIG. 1 is a block diagram of a mobile communication system, indicated generally by the reference numeral 10, in accordance with an example embodiment. The mobile communication system 10 comprises a low-earth orbit (LEO) satellite 11, a base station (or network node) 12, a second base station (or network node) 14 and a user device 16. The system 10 forms a non-terrestrial network (NTN) in which the user device 16 is able to communicate with one or more base stations/network nodes via the LEO satellite 11.

For example, the system 10 may be related to the 3GPP release 17 work item to support New Radio (NR) in non-terrestrial networks (NTN). One example implementation uses low-earth orbit (LEO) satellites at altitudes of 600 km to 1200 km to facilitate communications between user equipment (UE) and a base station on Earth. The LEO scenario differs from many terrestrial networks, because the communication distance and thus propagation delays are long, and furthermore the satellites move at a high speed (e.g. of about 7.5 km/s) relative to Earth. This may lead to frequent and unavoidable handovers for both stationary and moving UEs. According to an estimate captured in the TR 38.821, for a cell diameter of 50 km and satellite speed of 7.5 km/s, neglecting UE movement, a UE would have to handover once every 6.61 seconds.

It should be noted that the principles described herein are not restricted to use in NTN systems (such as the system 10). For example, other mobile communication systems in which significant signal propagation delays occurs may suffer from similar problems.

FIG. 2 is a plot, indicated generally by the reference numeral 20, showing signal strength data in accordance with an example embodiment. Specifically, the plot 20 comprises a first data 21 and second data 22. The first data 21 shows signal strength data, such as Reference Signal Received Power (RSRP) or Reference Signal Received Quality (RSPQ), between a user device (e.g. the user device 16) and a serving base station for the user device (e.g. the first base station 12) in an NTN system. The second data 22 shows signal strength data (e.g. RSRP or RSPQ) between the user device and a target base station (e.g. the second base station 14) of the NTN system.

Non-terrestrial networks (NTN) include relatively long propagation delays. For example, round-trip times (RTT) for signals between a user device and a base station could range between 10 to 20 ms based on the altitude of the satellite and the speed of satellite movement. Such problems can lead to potentially outdated UE measurements being received at the network and late/incorrect handover (HO) decisions resulting into degraded mobility performance. As indicated above, other mobile communication system may also suffer from relatively long propagation delays.

Existing event reporting criteria for mobility may be less effective in implementations (such as NTN LEO systems) having long propagation delays. Simulations suggest that handover failures are lower when the HO margin (e.g. cell individual offset, CIO) and Time-To-Trigger (TTT) are configured low, however this resulted (in one simulation) in a 30% rise in ping pongs and considerable increase in Radio Link Failures (RLFs). Analysis of simulation results suggest that the mobility performance may be dominated by handovers happening too late and that the handover preparation phase is seen most vulnerable since the handover process starts when the serving cell radio link is too weak.

The terms “signal strength” and “signal parameter” are used interchangeably throughout the specification, such that “signal strength” may represent any signal parameters (e.g. signal strength and/or signal quality).

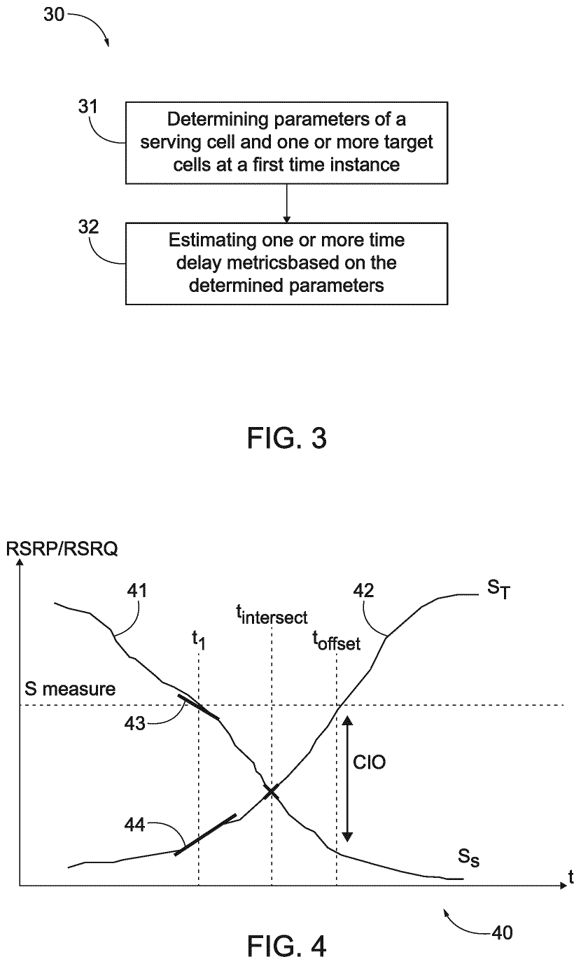

FIG. 3 is a flow chart showing an algorithm, indicated generally by the reference numeral 30, in accordance with an example embodiment. The algorithm 30 may be implemented at a user device of a mobile communication system (such as the user device 16 of the system 10 described above).

The algorithm 30 starts at operation 31, where one or more parameters of a serving cell and one or more target cells at a first time instance are determined at a user device of a mobile communication system (such as the user device 16 described above). As discussed further below, the parameters determined in the operation 31 may comprise signal strength rates of change of the serving cell and the one or more target cells.

At operation 32, one or more time delay metrics are estimated for each of the one or more target cells based on the parameters determined in the operation 31.

The time delay metrics estimated in the operation 32 may comprise:
A first time delay corresponding to a time period between the first time instance and a time instance at which the signal strength of the serving cell is predicted to match the signal strength of the respective target cell; and/or
A second time delay corresponding to a time period between the first time instance and a time instance at which the signal strength of the respective target cell is predicted to be higher than the signal strength of the serving cell by an offset value.

FIG. 4 is a plot, indicated generally by the reference numeral 40, showing signal strength data in accordance with an example embodiment. Specifically, the plot 40 comprises the first data 41 and the second data 42. The first data 41 shows signal strength data (e.g. RSRP or RSPQ) between a user device (e.g. the user device 16) and a serving base station for the user device (e.g. the first base station 12). The second data 42 shows signal strength data (e.g. RSRP or RSPQ) between the user device and a target base station (e.g. the second base station 14). Thus, the first and second data 41 and 42 are similar to the data described above with reference to the plot 20.

The one or more parameters of the serving cell determined in the operation 31 of the algorithm 30 described above may be a rate of change of the signal strength data 41 at time t₁ shown in the plot 40. That rate of change is indicated by the slope 43 shown in FIG. 3.

Similarly, the one or more parameters of the respective target cell determined in the operation 31 may be a rate of change of the signal strength data 42 at the time t₁. That rate of change is indicated by the slope 44 shown in FIG. 3.

The first time delay described above with reference to the operation 32 may be the time between the time t₁ and the time t_{intersect} indicated in FIG. 4, where the plots 41 and 42 intersect (i.e. the time period between a first time instance t₁ and the time instance at which the signal strength of the serving cell is predicted to match the signal strength of the respective target cell).

The second time delay described above with reference to the operation 32 may be time period between the time t₁ and the time t_{offset} indicated in FIG. 4 where the second plot 42 is predicted to be higher than the first plot 41 by a signal strength of the serving cell by an offset value, such as cell individual offset (CIO) (i.e. the time period between the first time instance t₁ and a time instance at which the signal strength of the respective target cell is predicted to be higher than the signal strength of the serving cell by said offset value).

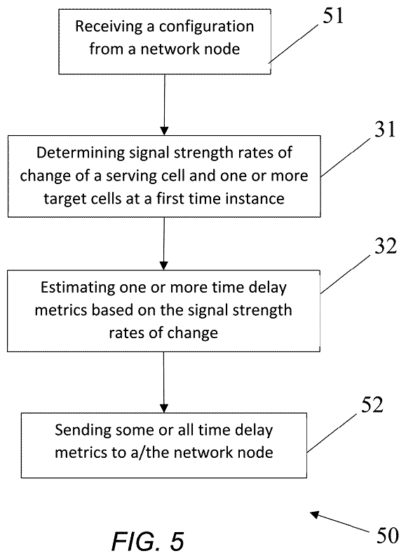

FIG. 5 is a flow chart showing an algorithm, indicated generally by the reference numeral 50, in accordance with an example embodiment. The algorithm 50 may be implemented at a user device of a mobile communication system (such as the user device 16 of the system 10 described above).

The algorithm 50 starts at operation 51, where configuration information is received (e.g. at a user device) from a network node of a mobile communication system. The configuration information provides information for configuring the user device to determine one or more parameters of a serving cell and one or more target cells at a first time instance. The configuration information may be provided in a radio resource control (RRC) message. The configuration information may identify the first time instance t₁ described above with reference to FIG. 4 or may provide trigger information that can used to determine that time.

Based on the configuration, the algorithm 50 moves to the operation 31 described above, in which parameters of the serving cell and the one or more target cells at a first time instance are determined. By way example, the operation 31 may comprise the user device evaluating the slopes 43 and 44 of the plot 40 described above from measured RSRP or RSRQ samples of the source and target cells. For example, the user device may determine slopes based on at least two (filtered) RSRP or RSRQ measurement samples separated in time.

With the parameters determined, the algorithm 50 moves to the operation 32 described above, in which one or more time delay metrics are estimated based on the determined parameters. By way of example, the operation 32 may comprise the user device using the evaluated slope 43 and 44 to estimate the time t_{intersect} at which the source cell signal strength drops to a level that would intersect with the increasing target cell signal strength and/or the time t_{offset} at which the target cell signal power is better by an offset amount (such as a cell individual offset amount) than the source cell signal strength.

At operation 52, some or all of said time delay metrics are sent to a network node of the mobile communication system, for example, for use in determining the optimal time point for performing said handover.

Thus, in an example implementation of the algorithm 50, a user device (such as the user device 16) uses the approximated slopes (gradients) 43 and 44 of measured signal strength variations of the source and target cells to estimate the projected delay for the source and the target cell signal to reach the configured threshold and trigger conditions including the condition to fulfil the event reporting criteria. The user device may further report the estimated delay values to the network to determine the optimal point to initiate a handover (HO) command, as discussed further below. In this way, the algorithm 50 may be used to at least partially compensate for the impact of large propagation delays in communication systems (such as NTN) and help in triggering handovers before the serving cell radio link becomes too weak.

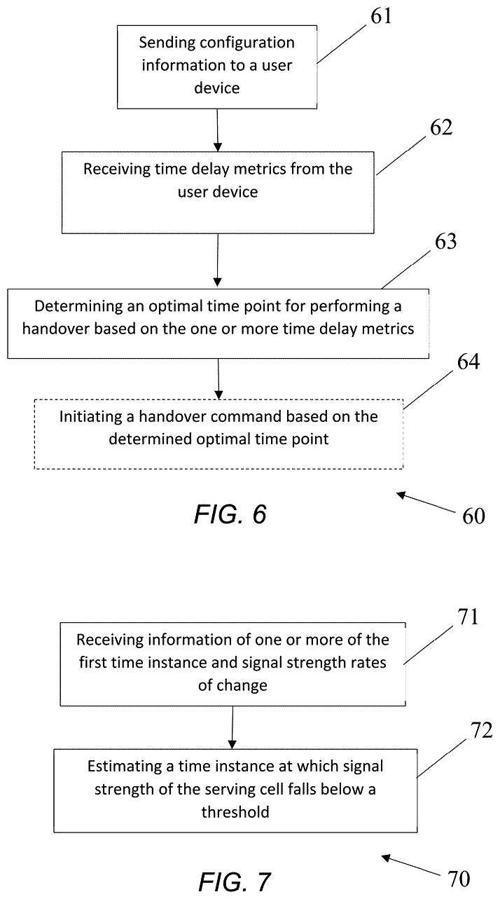

FIG. 6 is a flow chart showing an algorithm, indicated generally by the reference numeral 60, in accordance with an example embodiment. The algorithm 60 may be implemented at a network node of a mobile communication system (such as one of the base stations 12 and 14 described above).

The algorithm 60 starts at operation 61, where configuration information is sent to a user device of a mobile communication system. The configuration information may be the configuration information received in the operation 51 described above. The configuration information may be provided in a radio resource control (RRC) message.

The configuration information sent in the operation 61 may be such that the user device is caused to determine one or more parameters of a serving cell and one or more target cells at a first time instance and estimate one or more time delay metrics for each target cell based on said parameters (such as the time delay metrics discussed in detail above).

At operation 62, some or all of said time delay metrics are received from the user device. These may be the time delay metrics sent in the operation 52 described above.

At operation 63, the network node determines an optimal time point for performing a handover based, at least in part, on the one or more time delay metrics received from the user device.

Finally, at operation 64, the network node may initiate a handover command based on the determined optimal time point. It should be noted, however, that the handover may be controlled or initiated in some other way (e.g. by some other network entity).

FIG. 7 is a flow chart showing an algorithm, indicated generally by the reference numeral 70, in accordance with an example embodiment.

The algorithm 70 starts at operation 71, where various parameters are received at a network node of a communication system from a user device (such as the user device 16). The parameters may include the first time instance t₁ and/or some or all of the delay metrics described above.

At operation 72 of the algorithm 70, a time instance at which signal strength of the serving cell falls below a threshold is estimated based, at least in part, on the parameters received in the operation 71. The time instance determined in the operation 72 may indicate a time at which a signal from the serving cell is too weak. Thus, a user device may be configured to report the slope estimates to the network, thereby allowing the network to estimate the time for the serving cell radio link to become too weak. This estimation may form part of a handover decision process.

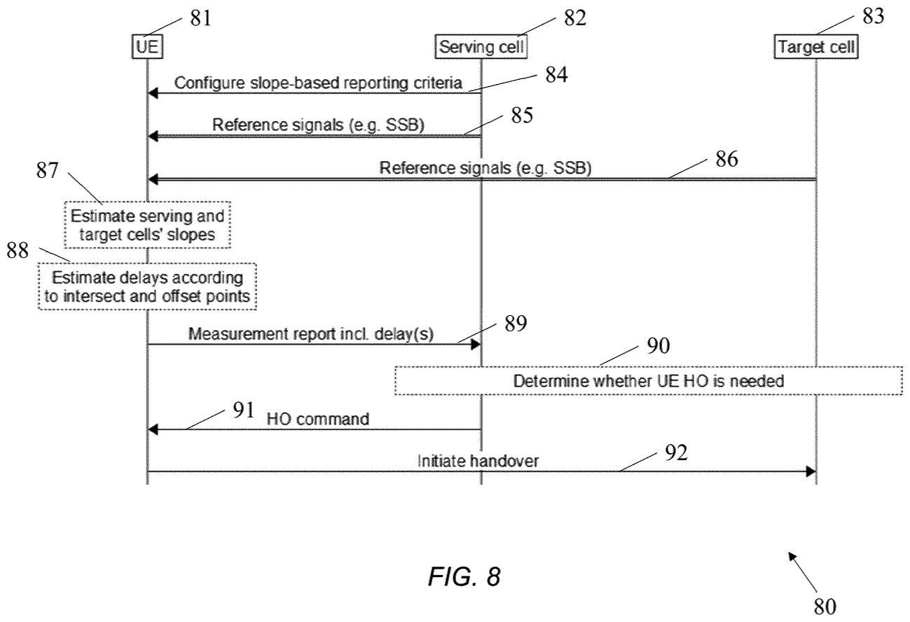

FIG. 8 is a message sequence, indicated generally by the reference numeral 80, in accordance with an example embodiment. The message sequence 80 shows message sent between a user device 81, a serving cell 82 and a target cell 83. The user device 81 may be the user device 16 of the mobile communication system 10 described above. The serving cell 82 and the target cell 83 may be the first base station 12 and the second base station 14 respectively. Of course, although only one target cell 83 is shown in the messages sequence 80, many target cells may be relevant is some example embodiments.

As discussed in detailed below, the message sequence illustrates how the serving cell 82 configures user device measurements and the subsequent reporting.

The message sequence 80 starts with a configure message 84 being sent from the serving cell 82 to the user device 81 by which the network configures the user device to enable the use of the criteria described herein for signal strength (e.g. RSRP) measurement and reporting by the user device. The network may configure UEs with the proposed criteria only for specific set of scenarios (e.g. LEO Earth moving cells or some other non-terrestrial network (NTN) scenarios). The user device also receives reference signal from the serving cell and the target cell in messages 85 and 86.

At a high level, there could be a new information element (IE) introduced in an existing measConfig RRC message under ReportConfigNR to indicate the trigger for the user device to apply the proposed criteria for UE measurements and reporting. (Additional parameters for applying the new criteria may also be signalled in the measConfig RRC messages e.g. parameters related to t_{intersect}, t_{offset})

An arrangement may also be provided for identifying and preparing suitable target cell and/or updating an existing list of target cells. The configure message 84 may include that list of target cells.

The user device is in communication with both the serving cell 82 and the target cell 83 (and possibly other target cells). As part of those communications, reference signals are received at the user device from the serving cell 82 (in the message 85) and the target cell 83 (in the message 86). Signal strength data (e.g. RSRP or RSRQ) may be determined from the received reference signals.

When configured, the user device 81 starts to evaluate the slope of measured signal strengths of the serving cell and one or more target cells using at least two consecutive signal strength measurement samples (in operation 87 of the message sequence 80). The user device may evaluate the slope periodically for all the measured samples (e.g. applicable for LEO scenarios with smaller beam or cell diameter).

In operation 88 of the message sequence 80, the user device 81 uses the evaluated slope to estimate at least one of the two delay values described above, namely:
t_{intersect}: the time where the relevant signal strengths intersect (e.g. the signal strengths of serving and target cell are equal). The time may be expressed as a dynamic or a relative delay (ms) compared to t₁; and
t_{offset}: the time where the signal strength of the target cell is CIO dB stronger than the serving cell. This is the point where UE would usually initiate TTT; the value can be expressed in SFN or relative delay (ms) compared to t₁.

The user device 81 sends a message 89 to the serving cell 82 that includes measurement information. For example, the user device may report some or all of the t₁ time, the estimated t_{intersect} time and the estimate t_{offset} time to the network. When t_{intersect} and/or t_{offset} are reported as absolute values, then the reporting of t₁ may be optional. When t_{intersect} and/or t_{offset} are reported as relative delay values, then the reporting of t₁ may be mandatory.

The user device 81 may optionally report the slope estimates to the network, which may allow the network to estimate the time for serving cell radio link to become too weak, as described above with reference to the algorithm 70.

Given the predictability of satellite movement, the network may use the data included in the message 89 to detect potential radio blockages, in which case the network can apply relevant criteria (e.g. A2 event criteria) to deal with the blockage.

The network may use the data included in the message 89 (such as the reported t_{intersect} and/or t_{offset} values) together with estimated propagation delay between the user device and the relevant network node to determine, in operation 90, an optimal point in time to initiate a handover command to the UE. The t_{intersect} and/or t_{offset} values can also be used by the UE to initiate the conditional handover (CHO).

The handover is implemented in the example message sequence 80 by a handover command 91 being sent by the serving cell 82 to the user device 81 and an initiate handover message 92 being sent from the user device 81 to the target cell 83. The skilled person will be aware of many alternative arrangements that could be used.

The use of an A3 event (CIO offset) is described above by way of example only. The principles described herein are applicable for other type of events too. When the network configures the UE to use the proposed reporting criteria, the network may initiate the HO command based on the reported t_{intersect} and t_{offset} values.

In some example embodiments, the network configures the user device to perform a specific set of measurements for the handover and then the user device provides the respective “predicted” values for the time where the signals from source and target intersect or when the time where the target cell is CIO dB stronger than the source. It defines a new measurement for the HO based on the RSRP slopes which is more suitable for NTN network. New parameters are proposed for a measurement report that triggers handover.

Using the principles described herein, handover failures can be reduced. In particular, the number of too early and too late handovers may be reduced.

As described above, one deployment scenario is in system comprises low-earth orbit (LEO) satellites at altitudes of 600 km to 1200 km in a transparent architecture to facilitate communication between user equipment (UE) and a base station on Earth. The LEO scenario is different to many terrestrial networks, because the communication distance and thus propagation delays are long, and furthermore the satellites move at a speed of about 7.5 km/s relative to Earth. As noted above, this will lead to frequent and unavoidable handovers for both stationary and moving UEs. The framework described herein may be used to partially compensate for the impact of large propagation delay in NTN and helps in controlling the HOs triggered before the serving cell radio link becomes too weak.

As noted above, the principles described herein may be applied in non-terrestrial networks, this is not a requirement. For example, the principles described herein could be applied in other mobile communication networks, such as networks that may experience large propagation delays.

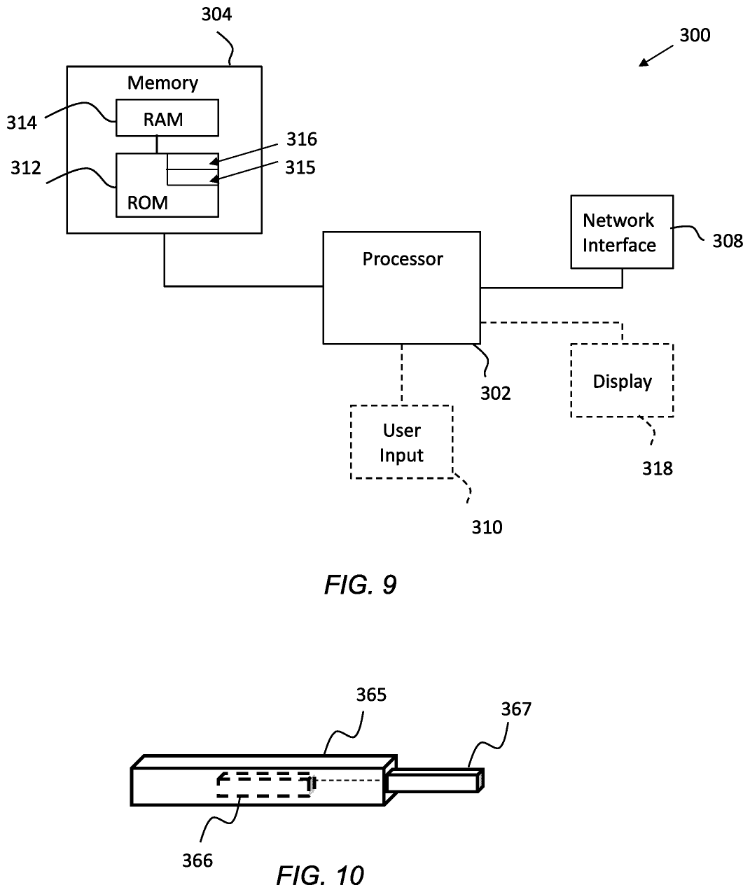

For completeness, FIG. 9 is a schematic diagram of components of one or more of the example embodiments described previously, which hereafter are referred to generically as a processing system 300. The processing system 300 may, for example, be (or may include) the apparatus referred to in the claims below.

The processing system 300 may have a processor 302, a memory 304 closely coupled to the processor and comprised of a RAM 314 and a ROM 312, and, optionally, a user input 310 and a display 318. The processing system 300 may comprise one or more network/apparatus interfaces 308 for connection to a network/apparatus, e.g. a modem which may be wired or wireless. The network/apparatus interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms and sequences 30, 50, 60, 70 and 80 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

FIG. 10 shows tangible media, specifically a removable memory unit 365, storing computer-readable code which when run by a computer may perform methods according to example embodiments described above. The removable memory unit 365 may be a memory stick, e.g. a USB memory stick, having internal memory 366 storing the computer-readable code. The internal memory 366 may be accessed by a computer system via a connector 367. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams and sequences of FIGS. 3 and 5 to 8 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. An apparatus comprising:
at least one processor; and
at least one memory including computer program code, wherein the at least one memory and the computer program code are configured, with the at least one processor, to cause the apparatus to perform the following:
determining, at a user device of a mobile communication system, one or more parameters of a serving cell and one or more target cells at a first time instance; and
estimating one or more time delay metrics for each of the one or more target cells based on said parameters, such that an optimal time point for performing a handover can be determined, wherein the time delay metrics comprise one or more of:
a first time delay corresponding to a time period between the first time instance and a time instance at which a signal parameter of the serving cell is predicted to match a signal parameter of the respective target cell; and
a second time delay corresponding to a time period between the first time instance and a time instance at which the signal parameter of the respective target cell is predicted to be higher than the signal parameter of the serving cell by an offset value.

2. An apparatus as claimed in claim 1, wherein the at least one memory and the computer program code are configured, with the at least one processor, to cause the apparatus to send some or all of said time delay metrics to a network node of the mobile communication system for use in determining the optimal time point for performing said handover.

3. An apparatus as claimed in claim 2, wherein the at least one memory and the computer program code are configured, with the at least one processor, to cause the apparatus to receive configuration information from the network node of the mobile communication system for configuring the user device to estimate said time delay metrics.

4. An apparatus comprising:
at least one processor; and
at least one memory including computer program code, wherein the at least one memory and the computer program code are configured, with the at least one processor, to cause the apparatus to perform the following:
sending configuration information to a user device of a mobile communication system, such that the user device is caused to:
determine one or more parameters of a serving cell and one or more target cells at a first time instance; and
estimate one or more time delay metrics for each target cell based on said parameters, wherein the time delay metrics comprise one or more of: a first time delay corresponding to a time period between the first time instance and a time instance at which the signal parameter of the serving cell is predicted to match the signal parameter of the respective target cell; and a second time delay corresponding to a time period between the first time instance and a time instance at which the signal parameter of the respective target cell is predicted to be higher than the signal parameter of the source cells by an offset value;
receiving some or all of said time delay metrics from the user device; and
determining an optimal time point for performing a handover based on the one or more time delay metrics received from the user device.

5. An apparatus as claimed in claim 4, wherein the at least one memory and the computer program code are configured, with the at least one processor, to cause the apparatus to initiate a handover command based on the determined optimal time point.

6. An apparatus as claimed in claim 5, wherein the at least one memory and the computer program code are configured, with the at least one processor, to cause the apparatus to receive the first time instance and/or some or all of said parameters from said user device.

7. An apparatus as claimed in claim 6, wherein the at least one memory and the computer program code are configured, with the at least one processor, to cause the apparatus to estimate, based at least in part on said parameters, a time instance at which signal parameter of the serving cell will fall below a threshold.

8. An apparatus as claimed in claim 7, wherein the at least one memory and the computer program code are configured, with the at least one processor, to cause the apparatus to identify and preparing suitable target cell and/or updating an existing list of target cells.

9. An apparatus as claimed in claim 8, wherein the configuration information identifies said first time instance or provides a trigger condition for identifying said first time instance.

10. An apparatus as claimed in claim 1, wherein the parameters comprise signal parameter rates of change of the serving cell and the one or more target cells.

11. An apparatus as claimed in claim 10, wherein the signal parameter rates of change relates to a rate of change of radio signal received power and/or radio signal received quality measurements measured by the user device.

12. An apparatus as claimed in claim 1, wherein the mobile communication system is a non-terrestrial network.

13. A method comprising:
determining, at a user device of a mobile communication system, one or more parameters of a serving cell and one or more target cells at a first time instance; and
estimating one or more time delay metrics for each of the one or more target cells based on said parameters, such that an optimal time point for performing a handover can be determined, wherein the time delay metrics comprise one or more of:
a first time delay corresponding to a time period between the first time instance and a time instance at which a signal parameter of the serving cell is predicted to match a signal parameter of the respective target cell; and
a second time delay corresponding to a time period between the first time instance and a time instance at which the signal parameter of the respective target cell is predicted to be higher than the signal parameter of the serving cell by an offset value.

14. (canceled)

15. (canceled)

16. A method as claimed in claim 13, further comprising sending some or all of said time delay metrics to a network node of the mobile communication system for use in determining the optimal time point for performing said handover.

17. A method as claimed in claim 16, further comprising receiving configuration information from the network node of the mobile communication system for configuring the user device to estimate said time delay metrics.
